(19) United States
(12) Patent Application Publication
(10) Pub. No.: US 2025/0292195 A1
(43) Pub. Date: Sep. 18, 2025

(54) INFORMATION PROCESSING DEVICE

(71) Applicant: TOYOTA JIDOSHA KABUSHIKI KAISHA, Toyota-shi (JP)

(72) Inventors: Tomiyasu ISHIKAWA, Okazaki-shi (JP); Tadashi MATSUI, Kasugai-shi (JP); Takumi KOZAWA, Nagoya-shi (JP); Yuto MOTOYAMA, Nagoya-shi (JP); Tsuyoshi OKADA, Nagoya-shi (JP); Yoshiaki MASUYA, Inazawa-shi (JP)

(73) Assignee: TOYOTA JIDOSHA KABUSHIKI KAISHA, Toyota-shi (JP)

(21) Appl. No.: 18/977,965

(22) Filed: Dec. 12, 2024

(30) Foreign Application Priority Data
Mar. 13, 2024 (JP) 2024-039429

(51) Int. Cl. G06Q 10/0834; G06Q 10/0631; G06Q 30/0207; G06Q 30/0283

(52) U.S. Cl. CPC G06Q 10/08345; G06Q 10/06316; G06Q 30/0207; G06Q 30/0284

(57) ABSTRACT

The cost and delivery date of the dealer delivery and the cost and delivery date of the factory delivery are calculated, and comparison information based on the cost and delivery date of the dealer delivery and the cost and delivery date of the factory delivery and delivery date of the factory delivery is presented to the user, and the selection of either the dealer delivery or the factory delivery is accepted.

### CROSS-REFERENCE TO RELATED APPLICATION

This application claims priority to Japanese Patent Application No. 2024-039429 filed on Mar. 13, 2024, incorporated herein by reference in its entirety.

### BACKGROUND

### 1. Technical Field

The present disclosure relates to an information processing device.

### 2. Description of Related Art

Conventionally, there has been disclosed acquiring, from information regarding a state of progress of a plurality of vehicles prior to delivery that is stored in a progress management database (DB), information regarding a state of progress of a particular vehicle corresponding to identification information thereof, and also providing the information that is acquired to a user terminal from which the identification information was sent (e.g., Japanese Unexamined Patent Application Publication No. 2002-297954 (JP 2002-297954 A)).

### SUMMARY

A situation may occur, for example, in which a vehicle has arrived at a dealer but has not been delivered yet, and a user feels stressed due to not knowing what is going on in the final stage. Further, it is difficult for users to freely select between having a vehicle delivered from a dealer (hereinafter, also referred to as “dealer delivery”) and having a vehicle delivered from a manufacturing factory (hereinafter, also referred to as “factory delivery”). Flexibly adjusting delivery schedules in accordance with selections made by users has not been studied much. As described above, there is room for improvement in schedule management technology prior to delivery.

In view of such circumstances, an object of the present disclosure is to improve schedule management technique prior to delivery.

An information processing device according to an embodiment of the present disclosure is
an information processing device including a control unit, in which the control unit
calculates cost and scheduled delivery date for dealer delivery, and cost and delivery date for factory delivery,
presents a user with comparison information based on the cost and scheduled delivery data for the dealer delivery, and the cost and the delivery date for the factory delivery, that are calculated, and
accepts selection of either the dealer delivery or the factory delivery.

According to an embodiment of the present disclosure, information providing technology related to vehicles is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment of the present disclosure;

FIG. 2 is a block diagram illustrating a schematic configuration of an information processing device;

FIG. 3 is a block diagram illustrating a schematic configuration of a terminal device;

FIG. 4 is a flow chart showing an operation of the information processing device; and

FIG. 5 illustrates an example of a user interface for presenting and accepting tasks that can be performed by a user.

### DETAILED DESCRIPTION OF EMBODIMENTS

Hereinafter, an embodiment of the present disclosure will be described.

### Outline of Embodiment

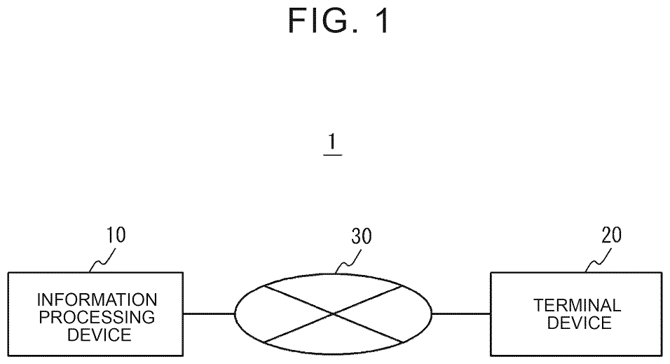

An outline and a configuration of the system 1 according to the present embodiment will be described with reference to FIG. 1.

The system 1 according to the present embodiment includes an information processing device 10 and a terminal device 20. The information processing device 10 and the terminal device 20 are communicably connected to a network 30 including, for example, a mobile communication network and the Internet.

The information processing device 10 is, for example, a server apparatus installed in a data center or the like. For example, the information processing device 10 is a server belonging to a cloud computing system or another computing system. The information processing device 10 can communicate with the terminal device 20 via the network 30. Although FIG. 1 illustrates an example in which one information processing device 10 is included in the system 1, the present disclosure is not limited to this. The system 1 may include two or more information processing devices 10.

The terminal device 20 is any device used by a user. The user includes a customer waiting for delivery of the vehicle. For example, a general-purpose electronic device such as a smartphone or a tablet terminal, or a dedicated electronic device can be employed as the terminal device 20. Although FIG. 1 illustrates an example in which one terminal device 20 is included in the system 1, the present disclosure is not limited to this. The system 1 may include two or more terminal devices 20.

First, the outline of the present embodiment will be described, and the details will be described later. The information processing device 10 calculates the cost of the dealer delivery, the scheduled delivery date, and the cost and delivery date of the factory delivery. Further, the information processing device 10 presents the user with comparison information based on the calculated cost of the dealer delivery, the scheduled delivery date, and the cost and delivery date of the factory delivery. Further, the information processing device 10 receives a selection of either a dealer delivery vehicle or a factory delivery vehicle.

As described above, according to the present embodiment, the information processing device 10 presents the comparison information based on the cost of the dealer delivery, the scheduled delivery date, and the cost of the factory delivery and the delivery date to the user. Further, the information processing device 10 receives a selection of either a dealer delivery vehicle or a factory delivery vehicle. In this way, the pre-delivery schedule management technique is improved in that the comparison information of the dealer delivery and the factory delivery is presented to the user, and the delivery schedule can be flexibly adjusted by the user's selection.

Next, each configuration of the system 1 will be described in detail.

### Configuration of Information Processing Device

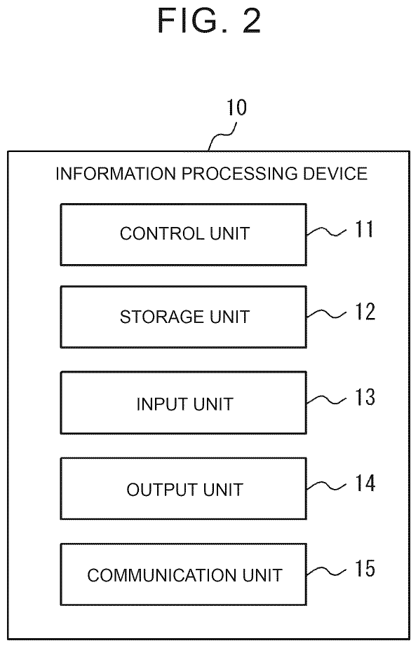

As illustrated in FIG. 2, the information processing device 10 includes a control unit 11, a storage unit 12, an input unit 13, an output unit 14, and a communication unit 15.

The control unit 11 includes at least one processor, at least one dedicated circuit, or a combination thereof. A processor is a general-purpose processor such as CPU (central processing unit) or GPU (graphics processing unit), or a special-purpose processor specialized for a particular process. The specialized circuit is, for example, a field-programmable gate array (FPGA), or an application specific integrated circuit (ASIC). The control unit 11 executes processing related to the operation of the information processing device 10 while controlling each unit of the information processing device 10.

The storage unit 12 includes at least one semiconductor memory, at least one magnetic memory, at least one optical memory, or a combination of at least two of these. The semiconductor memory is, for example, a random access memory (RAM) or a read-only memory (ROM). The RAM is, for example, a static random access memory (SRAM) or a dynamic random access memory (DRAM). The ROM is, for example, an electrically erasable programmable read only memory (EEPROM). The storage unit 12 may function as, for example, a main storage device, an auxiliary storage device, or a cache memory. The storage unit 12 stores data used for the operation of the information processing device 10 and data acquired through the operation of the information processing device 10.

The input unit 13 includes at least one input interface. The input interface is, for example, a touch screen integrally provided with a physical key, a capacitive key, a pointing device, and a display. The input interface may be, for example, a sound sensor that receives voice input, a camera that receives gesture input, or the like. The input unit 13 receives an operation of inputting data used for the operation of the information processing device 10. Instead of being provided in the information processing device 10, the input unit 13 may be connected to the information processing device 10 as an external input device. As the connecting method, any method such as USB (Universal Serial Bus), HDMI (registered trademark) (High-Definition Multimedia Interface), or Bluetooth (registered trademark) can be used, for example.

The output unit 14 includes at least one output interface. The output interface is, for example, a display for outputting information in video, a speaker for outputting information in audio, or the like. The display may be, for example, a liquid crystal display (LCD), an organic electroluminescence (EL) display, or the like. The output unit 14 displays and outputs data obtained by the operation of the information processing device 10. The output unit 14 may be connected to the information processing device 10 as an external output device instead of being provided in the information processing device 10. As a 10 connection method, for example, any method such as USB, HDMI (registered trademark), or Bluetooth (registered trademark) can be used.

The communication unit 15 includes at least one external communication interface. The communication interface may be either a wired communication or a wireless communication interface. For wired communication, the communication interface is, for example, LAN (Local Area Network) interface, USB (Universal Serial Bus). For wireless communication, the communication interface is an interface corresponding to a mobile communication standard such as LTE (Long Term Evolution), 4G (4th generation), or 5G (5th generation), or an interface corresponding to short-range wireless communication such as Bluetooth. The communication unit 15 receives data used for the operation of the information processing device 10 and transmits data obtained by the operation of the information processing device 10.

The function of the information processing device 10 is realized by executing the program according to the present embodiment by a processor corresponding to the information processing device 10. That is, the functions of the information processing device 10 are realized by software. The program causes the computer to execute the operation of the information processing device 10, thereby causing the computer to function as the information processing device 10. That is, the computer functions as the information processing device 10 by executing the operation of the information processing device 10 in accordance with the program.

In the present embodiment, the program can be recorded in a computer-readable recording medium. The computer-readable recording medium includes a non-transitory computer-readable medium such as a magnetic recording device, an optical disc, a magneto-optical recording medium, or a semiconductor memory. Distribution of the program is performed, for example, by selling, transferring, or lending a portable recording medium such as a DVD (digital versatile disc) or a CD-ROM (compact disc read only memory) in which the program is recorded. Further, the program may be distributed by storing the program in the storage of the external server and transmitting the program from the external server to another computer. Further, the program may be provided as a program product.

Some or all of the functions of the information processing device 10 may be realized by a dedicated circuit corresponding to the control unit 11. That is, some or all of the functions of the information processing device 10 may be realized by hardware.

### Configuration of Terminal Device

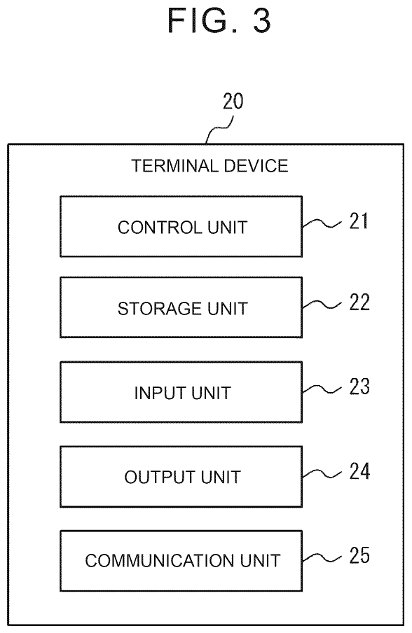

As illustrated in FIG. 3, the terminal device 20 includes a control unit 21, a storage unit 22, an input unit 23, an output unit 24, and a communication unit 25.

The control unit 21 includes at least one processor, at least one dedicated circuit, or a combination thereof. A processor is a general-purpose processor such as CPU (central processing unit) or GPU (graphics processing unit), or a special-purpose processor specialized for a particular process. The specialized circuit is, for example, a field-programmable gate array (FPGA), or an application specific integrated circuit (ASIC). The control unit 21 executes processing related to the operation of the terminal device 20 while controlling each unit of the terminal device 20.

The storage unit 22 includes at least one semiconductor memory, at least one magnetic memory, at least one optical memory, or a combination of at least two of these. The semiconductor memory is, for example, a random access memory (RAM) or a read-only memory (ROM). The RAM is, for example, a static random access memory (SRAM) or a dynamic random access memory (DRAM). The ROM is, for example, an electrically erasable programmable read only memory (EEPROM). The storage unit 22 functions as, for example, a main storage device, an auxiliary storage device, or a cache memory. The storage unit 22 stores data used for the operation of the terminal device 20 and data obtained by the operation of the terminal device 20.

The input unit 23 includes at least one input interface. The input interface is, for example, a touch screen integrally provided with a physical key, a capacitive key, a pointing device, and a display. The input interface may be, for example, a sound sensor that receives voice input, a camera that receives gesture input, or the like. The input unit 23 receives an operation of inputting data used for the operation of the terminal device 20. Instead of being provided in the terminal device 20, the input unit 23 may be connected to the terminal device 20 as an external input device. As the connecting method, any method such as USB (Universal Serial Bus), HDMI (registered trademark) (High-Definition Multimedia Interface), or Bluetooth (registered trademark) can be used, for example.

The output unit 24 includes at least one output interface. The output interface is, for example, a display for outputting information in video, a speaker for outputting information in audio, or the like. The display may be, for example, a liquid crystal display (LCD), an organic electroluminescence (EL) display, or the like. The output unit 24 displays and outputs data obtained by the operation of the terminal device 20. The output unit 24 may be connected to the terminal device 20 as an external output device instead of being provided in the terminal device 20. As a connection method, for example, any method such as USB, HDMI (registered trademark), or Bluetooth (registered trademark) can be used.

The communication unit 25 includes at least one external communication interface. The communication interface may be either a wired communication or a wireless communication interface. For wired communication, the communication interface is, for example, LAN (Local Area Network) interface, USB (Universal Serial Bus). For wireless communication, the communication interface is an interface corresponding to a mobile communication standard such as LTE (Long Term Evolution), 4G (4th generation), or 5G (5th generation), or an interface corresponding to short-range wireless communication such as Bluetooth. The communication unit 25 receives data used for the operation of the terminal device 20 and transmits data obtained by the operation of the terminal device 20.

The function of the terminal device 20 is realized by executing the program according to the present embodiment by a processor corresponding to the terminal device 20. That is, the function of the terminal device 20 is implemented by software. The program causes the computer to function as the terminal device 20 by causing the computer to execute the operation of the terminal device 20. That is, the computer functions as the terminal device 20 by executing the operation of the terminal device 20 in accordance with the program.

Some or all of the functions of the terminal device 20 may be realized by a dedicated circuit corresponding to the control unit 21. That is, a part or all of the functions of the terminal device 20 may be implemented by hardware.

### Operation of the Information Processing Device

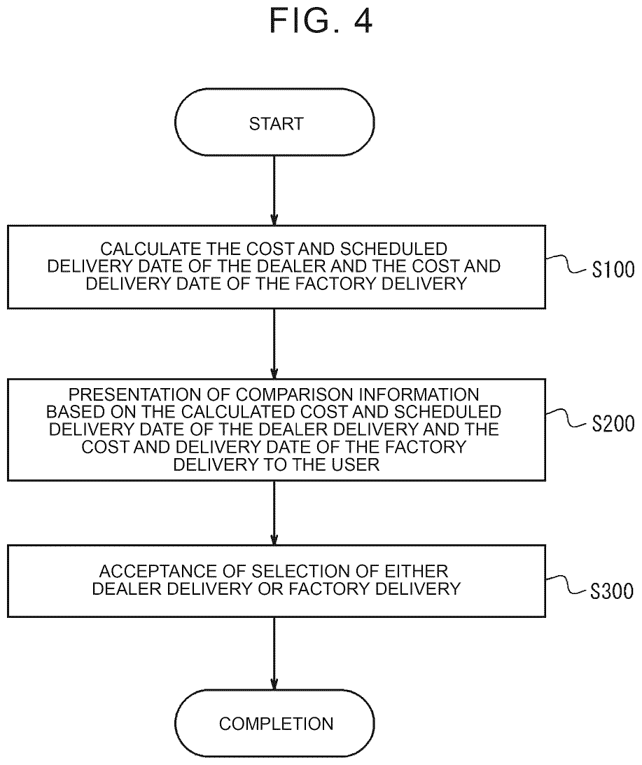

An operation of the information processing device 10 according to the present embodiment will be described with reference to FIG. 4.

S100: The control unit 11 of the information processing device 10 calculates the cost and the scheduled delivery date of the dealer delivery, and the cost and the delivery date of the factory delivery. The calculation process may be executed at an arbitrary timing when the vehicle is manufactured in the manufacturing factory. For example, the calculation process may be executed at a timing of a predetermined number of days before the assembly of the vehicle body is completed in the manufacturing factory.

An arbitrary method can be adopted for the calculation processing. For example, the control unit 11 may calculate the cost and the delivery date of the factory delivery based on the average cost and the average delivery date corresponding to the vehicle type and the time. Further, for example, the control unit 11 may calculate the cost and the scheduled delivery date of the dealer delivery based on the cost and the delivery date of the factory delivery. For example, the control unit 11 may calculate the cost associated with the delivery of the dealer by adding an additional cost such as a transportation cost to the cost associated with the delivery of the factory. Further, the control unit 11 may calculate the scheduled delivery date related to the delivery of the dealer by adding the average required days of the number of transportation days and the number of task steps at the dealer to the scheduled delivery date related to the delivery of the factory.

S200: The control unit 11 generates comparison information on the basis of the cost of the dealer delivery and the scheduled delivery date calculated in S100, and the cost and delivery date of the factory delivery, and presents the comparison information to the user. For example, the comparison information may include all information on the cost and scheduled delivery date of the dealer delivery, and the cost and delivery date of the factory delivery. Alternatively, the comparison information may include some information among the cost of the dealer delivery and the scheduled delivery date, and the cost of the factory delivery and the delivery date information. For example, the comparison information may be information on a cost difference between the dealer delivery and the factory delivery, and a difference between scheduled delivery dates.

Any method can be adopted for presentation of the comparison information. For example, the control unit 11 may present comparison information through a user interface displayed and output by the output unit 24 of the terminal device 20. Such a user interface may be presented by the terminal device 20 accessing the information processing device 10 or the web server via the browser software. Alternatively, an application related to the system 1 may be installed in the terminal device 20. The user interface may be presented by the terminal device 20 appropriately communicating with the information processing device 10 or the application server via the application. In this case, the terminal device 20, the information processing device 10, or the terminal device 20 and the web server may appropriately perform authentication processing and the like for the user.

S200: The control unit 11 receives, from the user, a selection of either a dealer delivery vehicle or a factory delivery vehicle. Based on the selection, it may be determined whether the delivery method for the user is a dealer delivery or a factory delivery.

An arbitrary method can be adopted for the process of accepting the selection. For example, the control unit 11 may receive a selection operation from the terminal device 20 via the communication unit 15 and the network 30. In this case, for example, the output unit 24 of the terminal device 20 may display and output a user interface that allows a user to select either a dealer delivery vehicle or a factory delivery vehicle. In addition, the control unit 21 may receive the selection of the user by the input unit 23, and transmit the received information to the information processing device 10 via the communication unit 25 and the network 30. Based on the selected information, the delivery person can switch the delivery method of the vehicle to the user.

As described above, the information processing device 10 according to the present embodiment calculates the cost of the dealer delivery, the scheduled delivery date, and the cost and delivery date of the factory delivery, and presents the comparison information based on the calculated cost and delivery date to the user. Further, the information processing device 10 receives a selection of either a dealer delivery vehicle or the factory delivery vehicle. According to this configuration, the pre-delivery schedule management technique is improved in that the comparison information of the dealer delivery and the factory delivery is presented to the user, and the delivery schedule can be flexibly adjusted by the user's selection.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, the control unit 11 of the information processing device 10 may further present an task that can be performed by the user, and may receive an task performed by the user among the tasks. The user-executable tasks may include installation of a floor mat, documentation procedures, and/or component installation tasks. As described above, by accepting the task performed by the user, the user can deal with a part of the task by himself/herself and adjust the delivery date and the like.

Further, the control unit 11 may further present a reduction cost and a shortened number of delivery days when the user performs a task that can be performed by the user. In this way, it is possible to provide a material for determining which of the tasks that can be performed by the user is actually performed from the viewpoint of cost and effectiveness.

Further, the control unit 11 may also present the difficulty level of the task that can be performed by the user. By doing so, it is possible to provide a material for determining which of the tasks that can be performed by the user is actually performed from the viewpoint of difficulty level.

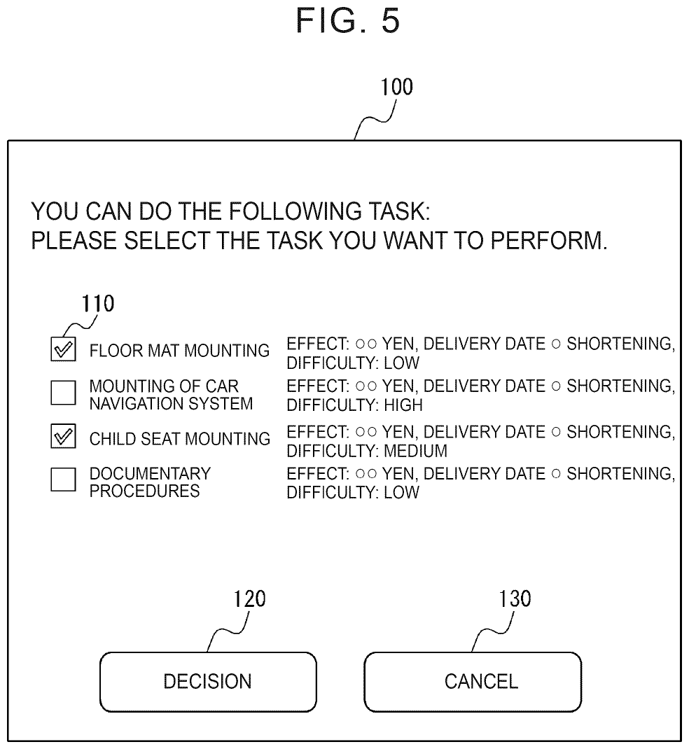

FIG. 5 illustrates an example of a user interface for presenting and accepting tasks that can be performed by a user. The user interface 100 illustrated in FIG. 5 includes a check box 110 for each task that can be performed by the user, an enter button 120, and a cancel button 130. As illustrated in FIG. 5, the reduction cost, the shortened delivery date, and the difficulty level may be displayed for each task that can be performed by the user. The user can register the task desired to be performed by selecting the task desired to be performed by the check box 110 and pressing the enter button 120. The user can also cancel the selection as appropriate by pressing the cancel button 130.

1. An information processing device, comprising
a display, and
a processor configured to:
calculate cost and a delivery date for vehicle dealer delivery, and cost and a delivery date for vehicle factory delivery,
wherein a user takes delivery from a vehicle dealer in the vehicle dealer delivery, and the user takes delivery from a vehicle factory in the vehicle factory delivery, and
wherein the processor calculates the cost and the delivery date for the vehicle factory delivery a predetermined number of days before an assembly completion date of a vehicle at the vehicle factory, and calculates the cost and the delivery date for the vehicle dealer delivery by adding cost and number of days required to transport the vehicle from the vehicle factory to the vehicle dealer to the cost and the delivery date for the vehicle factory delivery:
generate comparison information indicating the cost and the delivery date for the vehicle dealer delivery, and the cost and the delivery date for the vehicle factory delivery, that are calculated;
provide remote access to the user over a network to enable the user to refer to the comparison information through a user interface on a user terminal of the user;
present the comparison information to the user via the user interface to prompt the user to input a selection of either the vehicle dealer delivery or the vehicle factory delivery to the user interface:
receive the input to the user interface made by the user to accept the selection; and
cause the display to display the accepted selection.

2. The information processing device according to claim 1, wherein
the user interface indicates
one or more tasks that the user can perform on the vehicle, and
a checkbox icon for each of the one or more tasks that is selectable by the user to indicate selected tasks from among the one or more tasks, and
the processor is further configured to receive an input to the checkbox icon to indicate acceptance by the user of the selected tasks from among the one or more tasks.

3. The information processing device according to claim 2, wherein the user interface further indicates a reduced cost and a reduced number of days until delivery of the vehicle for each of the one or more tasks, wherein the reduced cost and the reduced number of days are achieved when the user performs the corresponding task.

4. The information processing device according to claim 2, wherein the user interface further indicates a difficulty level for each of the one or more tasks.

5. The information processing device according to claim 2, wherein the one or more tasks include at least one of installation of a floor mat, paperwork, and attachment of a component.

6. An information processing device, comprising
a display, and
a processor configured to:
calculate cost and a delivery date for vehicle dealer delivery, and cost and a delivery date for vehicle factory delivery,
wherein a user takes delivery from a vehicle dealer in the vehicle dealer delivery, and the user takes delivery from a vehicle factory in the vehicle factory delivery, and
wherein the processor calculates the cost and the delivery date for the vehicle factory delivery a predetermined number of days before an assembly completion date of a vehicle at the vehicle factory, and calculates the cost and the delivery date for the vehicle dealer delivery by adding cost and number of days required to transport the vehicle from the vehicle factory to the vehicle dealer to the cost and the delivery date for the vehicle factory delivery;
generate comparison information indicating the cost and the delivery date for the vehicle dealer delivery, and the cost and the delivery date for the vehicle factory delivery, that are calculated;
provide remote access to the user over a network to enable the user to refer to the comparison information through a user interface on a user terminal of the user;
present the comparison information to the user via the user interface to prompt the user to input a selection of either the vehicle dealer delivery or the vehicle factory delivery to the user interface;
receive the input to the user interface made by the user to accept the selection; and
cause the display to display the accepted selection, wherein,
the user interface indicates
one or more tasks that the user can perform on the vehicle,
a reduced cost and a reduced number of days until delivery of the vehicle for each of the one or more tasks, wherein the reduced cost and the reduced number of days are achieved when the user performs the corresponding task,
a difficulty level for each of the one or more tasks,
a checkbox icon for each of the one or more tasks that is selectable by the user to indicate selected tasks from among the one or more tasks, and
an enter button icon, and
the processor is further configured to
receive an input to the checkbox icon to indicate acceptance by the user of the selected tasks from among the one or more tasks, and
receive an input to the enter button icon to register the selected tasks.

7. The information processing device according to claim 3, wherein the user interface further indicates a difficulty level for each of the one or more tasks.

8. The information processing device according to claim 6, wherein the one or more tasks include at least one of installation of a floor mat, installation of a car navigation system, and installation of a child seat.
